(19) United States
(12) Patent Application Publication
(10) Pub. No.: US 2012/0232919 A1
(43) Pub. Date: Sep. 13, 2012

(54) Methods, Apparatuses and Systems for Analyzing Healthcare Data

(75) Inventors: John Wilson, Minneapolis, MN (US); Martin Evan Hétu, Newport Beach, CA (US); Hasani Jess, London (GB); Peter Olson, Plymouth, MN (US)

(73) Assignee: Optumlnsight, Inc., Eden Prairie, MN (US)

(21) Appl. No.: 13/327,599

(22) Filed: Dec. 15, 2011

Related U.S. Application Data
(60) Provisional application No. 61/451,655, filed on Mar. 11, 2011.

(51) Int. Cl. G06Q 50/22

(52) U.S. Cl. 705/2

(57) ABSTRACT

Systems, methods and apparatuses for analyzing healthcare data are disclosed. In some embodiments, a system for analyzing healthcare data may include a data access module configured to access healthcare data. In some embodiments, the system may further include a server in data communication with the data access device. The server may be configured to execute a rule, the rule comprising one or more rule elements, on the healthcare data to create analyzed healthcare data. In some embodiments, executing the rule may include, correlating each rule element with an object model element. In some embodiments, executing the rule further may include, defining the object model elements correlated to the rule elements using one or more localization indexes linked to the accessed healthcare data. In some embodiments, the server is further configured to return the analyzed healthcare data to an output data location.

### CROSS-REFERENCE TO RELATED APPLICATIONS

This application claims the benefit of U.S. Provisional Application No. 61/451,655 filed Mar. 11, 2011, the entire contents of which is specifically incorporated herein by reference without disclaimer.

### BACKGROUND OF THE INVENTION

### Field of the Invention

This invention relates to data processing in the healthcare industry and more particularly relates to methods, apparatuses, and system designed to enable adaptable analytics of healthcare data that can be customized according to architecture, geography, data source, and coding system.

### SUMMARY OF THE INVENTION

Systems, methods, and apparatuses for analyzing healthcare data are disclosed. In some embodiments, a system for analyzing healthcare data may include a data access module configured to access healthcare data. In some embodiments, the system may further include a server in data communication with the data access device. The server may be configured to execute a rule, the rule comprising one or more rule elements, on the healthcare data to create analyzed healthcare data. In some embodiments, executing the rule may include, correlating each rule element with an object model element. In some embodiments, executing the rule further may include, defining the object model elements correlated to the rule elements using one or more localization indexes linked to the accessed healthcare data. In some embodiments, the server may be further configured to return the analyzed healthcare data to an output data location.

In some embodiments, the accessed healthcare data may include a first set of accessed healthcare data and a second set of accessed healthcare data. Moreover, in some embodiments, the one or more localization indexes may include a first localization index linked to the first set of accessed data and a second localization index linked to the second set of accessed data.

In some embodiments, the first set of accessed data may include data in a first language and the second set of accessed data may include data in a second language.

In some embodiments, the first set of accessed data comprises data organized using a first coding scheme and the second set of accessed data comprises data organized using a second coding scheme.

In some embodiments, the server may be further configured to receive a rule verbalization expressing a rule. In some embodiments, the server may further be configured to parse the rule verbalization to determine the one or more rule elements of the rule.

In some embodiments, data access module may configured to receive data from at least a file, a database, and a programming object.

In some embodiments, the output data location may include at least a file, a database, and a programming object.

Methods of analyzing healthcare data are also disclosed. In some embodiments of the method, the method may access healthcare data. In some embodiments, the method may further execute a rule, the rule including one or more rule elements, on the healthcare data to create analyzed healthcare data. In some embodiments, the method step of executing the rule may include correlating each rule element with an object model element and defining the object model elements correlated to the rule elements using one or more localization indexes linked to the accessed healthcare data. In some embodiments, the method may further include returning the analyzed healthcare data to an output data location.

A computer program product is also disclosed. In some embodiments, the computer program product may include a computer readable medium having computer usable program code executable to perform operations for analyzing healthcare data. In some embodiments, operations of the computer program product may include the steps of the all the embodiments of the disclosed methods.

The term “rule” (also referred to as a business rule) is defined as a logical statement to be executed on a set of data to perform a function. Moreover, a rule may include statement to find data within a database that has a specific characteristic. In various embodiments of a rule, the found data may be returned to the user in the form of a user output, the found data may be manipulated by the rule, and/or otherwise flagged in the database for further analysis.
If a healthcare claim has an “assigned provider” of Dr. Steven Jones and a “healthcare provider ID” of 11223344, substitute the “assigned provider” with Dr. Stephen Jones.
If members of the same family have the same or similar set of symptoms, flag those family members for further fraud analysis.
If a patient has diabetes and has not had an HBA1c test then flag for population management.

The term “rule library” is defined as a collection of rules commonly associated with a specific healthcare domain. For example, rule libraries may be associated with fraud analysis, clinical analysis, health coaching, population management, and the like. As discussed in more detail through the disclosure, particular rule libraries may include a set of rules specific to architecture, geography, data source, and/or coding system.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a schematic block diagram illustrating one embodiment of a system for analyzing healthcare data;

FIG. 1B is a schematic block diagram illustrating a specific embodiment of a system for analyzing healthcare data;

FIG. 2 is a schematic block diagram illustrating one embodiment of a database system for analyzing healthcare data;

FIG. 3 is a schematic block diagram illustrating one embodiment of a computer system that may be used in accordance with certain embodiments of the system for analyzing healthcare data;

FIG. 4 is a schematic block diagram illustrating the object model when analyzing healthcare data;

FIG. 5 is a schematic flow chart diagram illustrating one embodiment of a method for analyzing healthcare data;

FIG. 6 is a screenshot illustration of creating a new rule using a rule configuration module;

FIG. 7 is a screenshot illustration of defining a rule using a rule configuration module;

FIGS. 8A, 8B, 8C, and 8D are screenshot illustrations of defining/editing a rule using a rule configuration module;

FIG. 9 is as screenshot illustration of defining a rule using a decision table within a configuration module; and

FIGS. 10A, 10B, and 10C are screenshot illustrations of a rule testing module.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

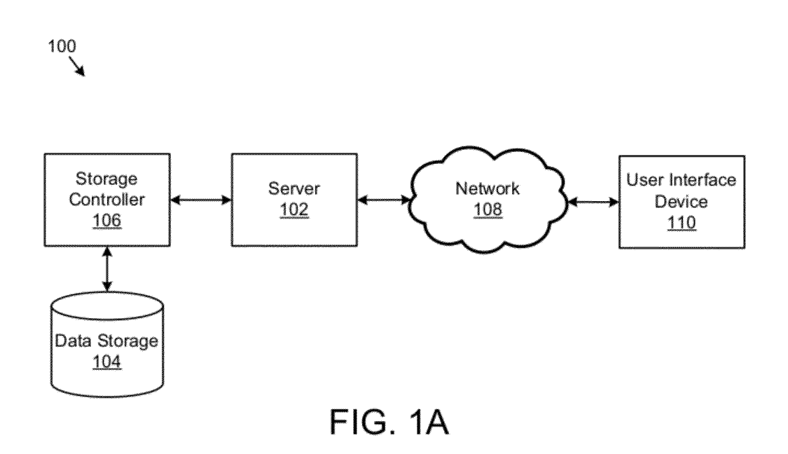

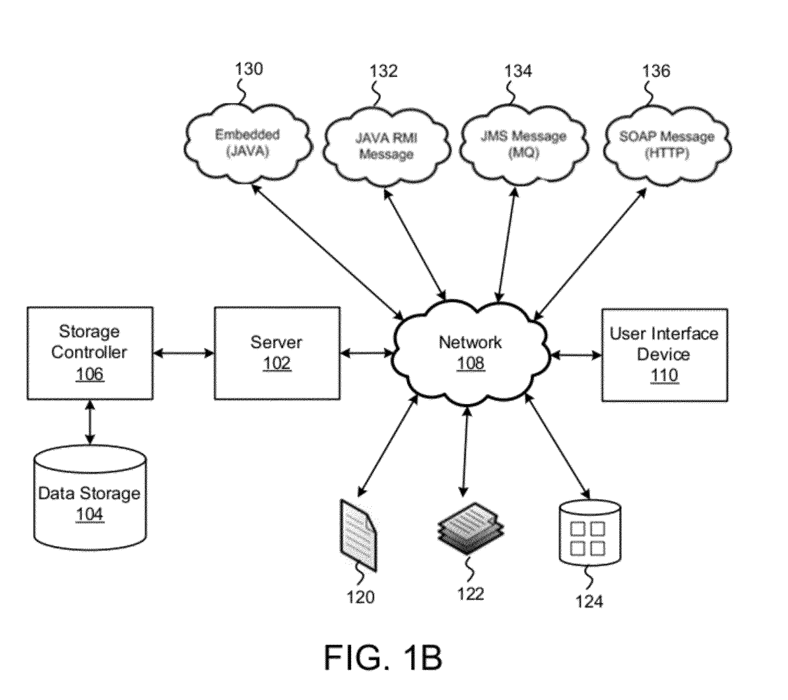

FIG. 1A illustrates one embodiment of a system 100 for analyzing healthcare data. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may configured to execute rules on flexible data sets. Specifically, the system 100 may be configured to enable the analysis of healthcare of specific data that with a single rules engine—using rules and data from various data sources, architectures, geographies, and coding systems.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter patient healthcare data, specific rules to be executed, data to be analyzed, and/or other processing instructions. Specifically, as shown with respect to FIG. 1B these user inputs maybe in the form of an XML file input 120, flat file input 122, database file input 124, query inputs, object inputs, and the like. The XML file, flat file, and database file, shown in FIG. 1B, are accessible through network 108. In other embodiments, the various inputs may be locally stored, manually input, or otherwise accessible (e.g., through data storage device 104).

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another. As shown with respect to FIG. 1B, in specific embodiments of system 100, the network may be configured to communicate using a variety of known protocols including HTTP (e.g., a SOAP message), MQ (e.g., a JMS message), a JAVA RMI message, embedded JAVA message or the like. One of skill in the art will recognize a variety of other networking protocols and communications schemes that may be used to communicate healthcare data.

In one embodiment, the server 102 is configured to execute a rule on accessible healthcare data and return analyzed healthcare data to an output data location. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

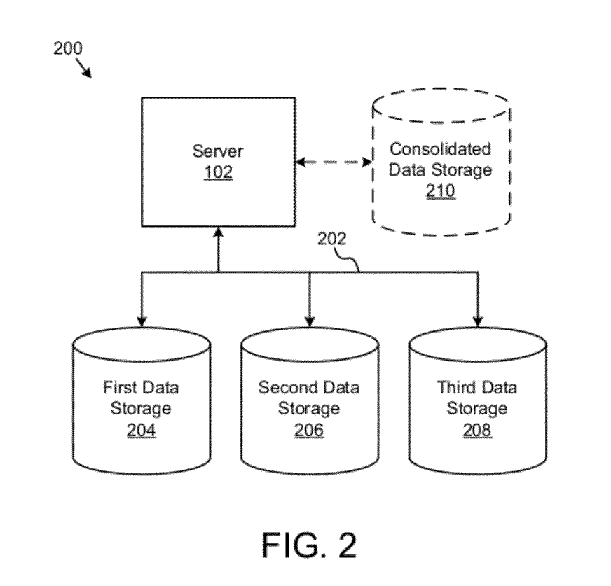

FIG. 2 illustrates one embodiment of a data management system 200 configured to store and manage data for analyzing healthcare data. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of various rule libraries, healthcare data, and/or localization information. For example, in a database storing healthcare data, the customer/patient information in each database may be keyed to a common field or identifier, such as an individual's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements associated with an individual or group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 204-210; the server first communicating with a storage server or storage controller 106.

In one example of the system 200, the first data storage device 204 may store healthcare data associated with insurance claims, medical records data, and/or benefits data associated with one or more individuals. The healthcare data may include data associated with medical services, procedures, and prescriptions utilized by the individual. In one particular embodiment, the first data storage device 202 may include healthcare data for individuals based in a specific country (e.g., the United States).

In one embodiment, the second data storage device 206 also may store healthcare data that includes data associated with medical services, procedures, and prescriptions utilized by the individuals in the database. However, the second data storage device 206 may include healthcare data from individuals based in another country. As such, though this data may include the same types of data (e.g., patient identifiers, disease identifiers, treatment identifiers, physician identifiers and the like), the data may be stored in a materially different matter. For example, database 204—which may store information for U.S. based individuals—would likely store such data in English and follow the practices and localizations particular to U.S. based healthcare standards (i.e., diseases identifiers may be represented using ICD9). Database 206—which may store information for U.K. based individuals—would also store such data in English, but would follow the practices and localizations particular to U.K. based healthcare (i.e., disease identifiers may be represented by ICD10, READ code v2, and/or READ code v3).

The above example, regarding a U.S. and U.K. based databases exemplifies that various embodiments of system 200 may include healthcare data stored in any country (e.g., including various languages such as English, Spanish, and French) and using a variety of different data structures and coding schemes. Moreover, the healthcare data stored in various databases is not simply limited to insurance claims and medical records data, but rather includes any compilation of data specific to fraud management, prescription usage, individual's interaction or transactions on a website, calls to a customer service line, or utilization of a preventative medicine health program. Other examples of various healthcare data sources are included without limitation throughout this disclosure. Additionally, one having skill in the art will recognize other applicable healthcare data sources.

The third data storage device 208 may include data associated with rule libraries. For example, the data associated with a rules library may include the collection of rules that make up the rules library. In some embodiments, this data may further include a database storing healthcare data specific to those rules. In a specific example, the Healthcare Effectiveness Data and Information Set (HEDIS) are rules reflective of dimensions of healthcare and service, and a specific HEDIS rule library may be written to analyze a database containing elements which house HEDIS claims and clinical data. Similarly, a specific rule library may be compiled to analyze healthcare claims data for a particular health insurance provider. One having skill in the art will recognize several different examples and types of rules libraries as well as databases that are associated with those rules libraries.

The server 102 may host a software application configured for analyzing healthcare data. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

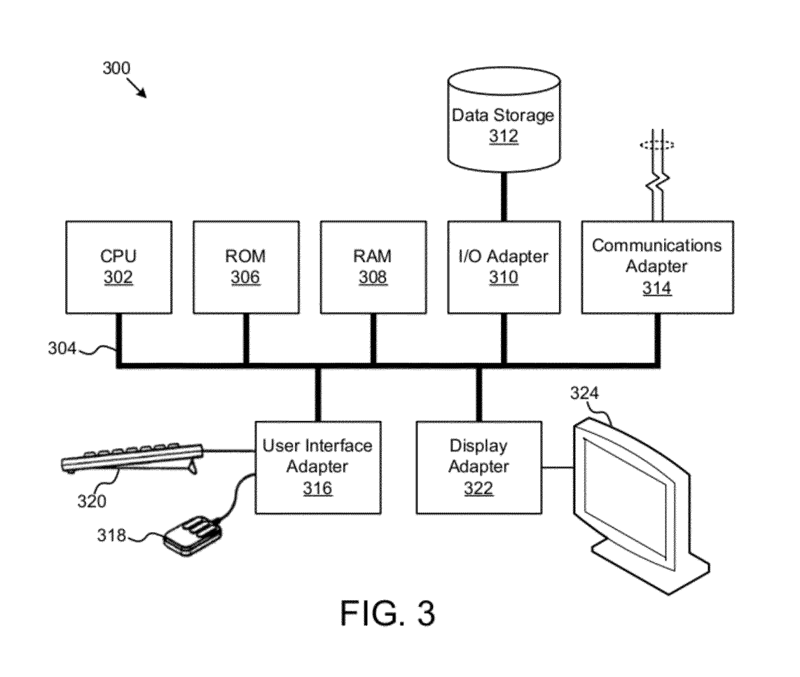

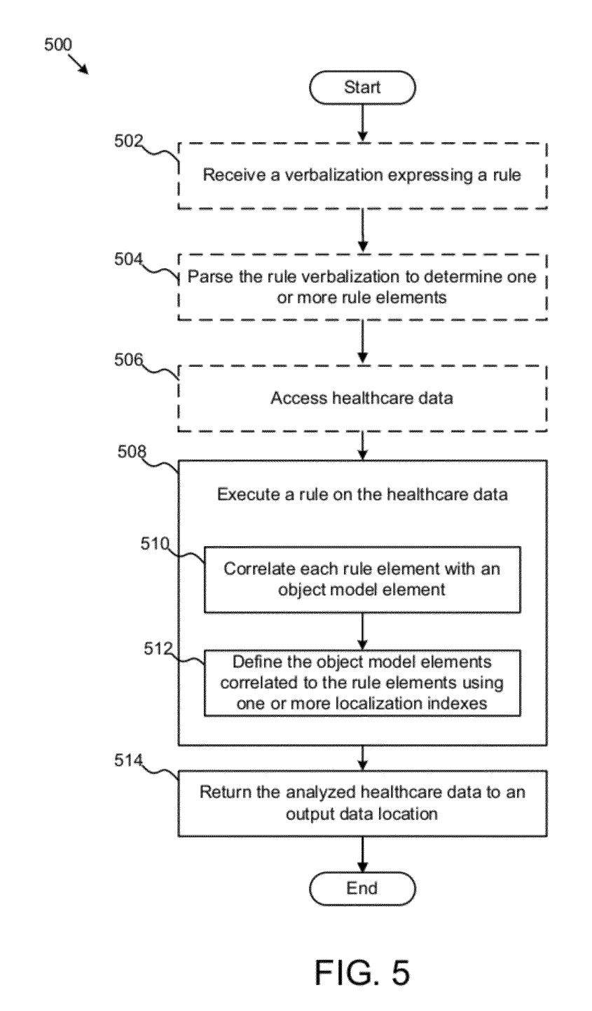

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIG. 5.

The computer system 300 also may include Random Access Memory (RAM) 308, which may be SRAM, DRAM, SDRAM, or the like. The computer system 300 may utilize RAM 308 to store the various data structures (e.g., object model) used by a software application configured to analyze healthcare. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information. In a further embodiment, the display adapter 322 may display a graphical user interface associated with a software or web-based application for analyzing healthcare data.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, multi-processor servers, and the like. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

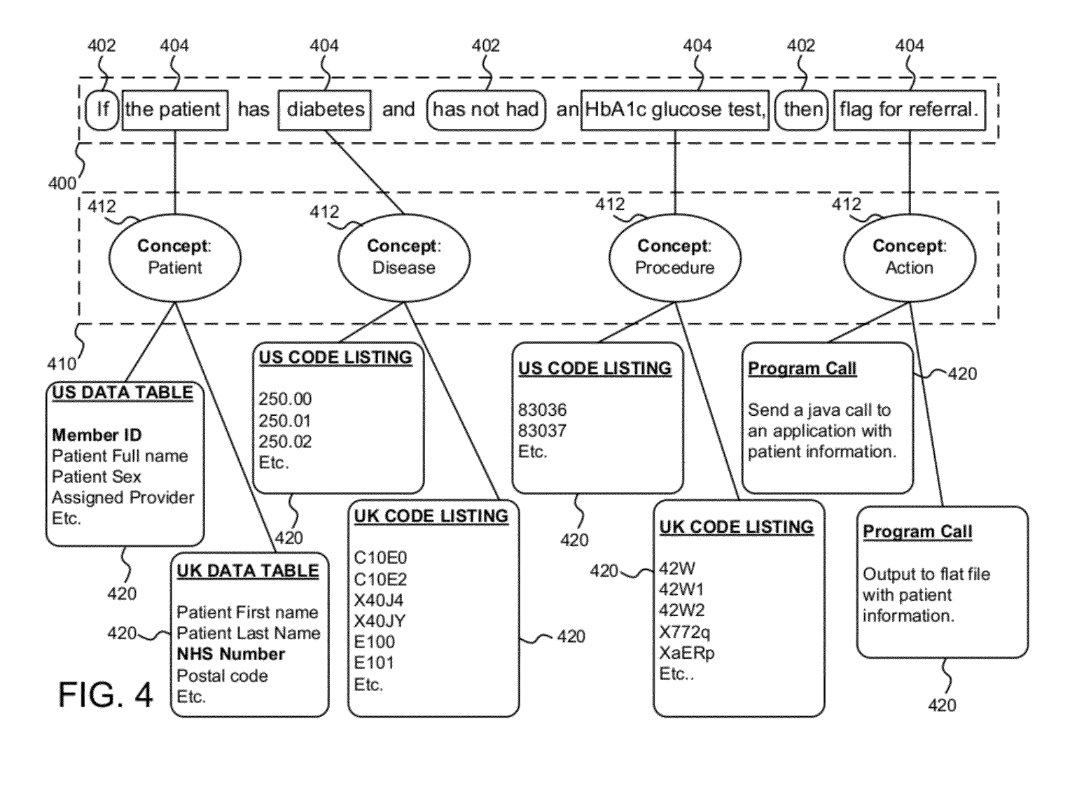

FIG. 4 illustrates a block diagram illustrating the object model for analyzing healthcare data. FIG. 5 illustrates one embodiment of a method 500 for analyzing healthcare data. The server 102 shown in FIGS. 1A, 1B, and 2 may be configured to execute the steps of method 500. Similarly, in some embodiments, CPU 302 of FIG. 3 may be configured to execute the steps of method 500. Moreover, each of the various steps discussed with respect to method 500 may implemented as one or more software and/or hardware modules. The FIGS. 4 and 5 are described herein in parallel.

Generally, the method 500 illustrates embodiments for executing a rule on a set of healthcare data. Examples of various rules that may be executed on various healthcare data sets are provided in the Summary of the Invention section of this disclosure and may also be found throughout this disclosure. FIG. 4 further provides a specific example of a rule that may be executed on healthcare data. Rule 400 states “If the patient has diabetes and has not had an HbA1c glucose test, then flag for referral.” As shown with respect to FIG. 4, each rule may include logical elements 402 and rule elements 404. Example of logical elements 402 may further include qualifiers (e.g., all, over the age of 17, under the age of 17, outpatient, inpatient, and the like), conditionals (e.g., if, when, then, do, else, and the like), and/or operators (e.g., and, or, false, true, exceeds/in excess of, is equal to/no equal, has, has at least, with, without, between, is greater than, is less than, and the like). With respect to rule 400, “if' and “then” are examples of conditional logical elements, and “has not had” is an example of a qualifier logical element. Examples of rule elements 404 may further include various nouns and verbs identifying healthcare data elements and actions. With respect to rule 400, the rule elements 404 include “patient’ (i.e., a noun identifying a person); diabetes (i.e., a noun identifying a specific condition), HbA1c glucose test (i.e., a noun phrase identifying a specific procedure), flag for referral (i.e., a verb phrase identifying the output action).

Appendix A provides two tables describing how various logical elements and rule elements may be combined together to form a rule. The tables provided in Appendix A are simply provided as a non-limiting example only. As shown, a conditional, a noun, a noun qualifier, operator, value can be combined together to form a rule input, and likewise a conditional and output can be combined to form a rule output. One rule that may be formed is by combing the various columns in Appendix A is, “If the age of a patient exceeds 18 years, then identify the patient as an adult.” Many, if not all, of the rule elements/object model elements disclosed in Appendix A may belong to an embodiment of the general object model discussed later in this disclosure.

In one embodiment, the method 500 may begin by receiving 502 a verbalization expressing a rule. This verbalization of a rule may be received from a user interface device (e.g., user interface 110). Similarly, the rule verbalization may also be received by another form of input (e.g., a file, an XML file, or database). In some embodiments, the rule verbalization may be composed in a domain specific language, and in other embodiments, the rule verbalization may be composed in a natural language. As discussed in more detail below, in some embodiments, a rule verbalization may be received from a Rule Configuration Module. In some embodiments of the invention, the rule verbalization may be parsed 504 to determine the rule to be executed. In some embodiments, parsing the rule verbalization may include determining the various logical elements and rule elements of a rule. For example, a rule composed in a natural language may be converted from a natural language rule to a domain specific language for analyzing healthcare data. As such, the ability to use natural language allows business users to create complex rules in a natural language using phrases and terms that are familiar to them—without the need for technical staff intervention. Moreover, both technical users and business users alike may be able to create rules in a greatly reduced time frame.

Method steps 502 and 504 are optional. In some embodiments, for example, there may be no need to either explicitly receive a rule verbalization and/or parse the rule verbalization. For example, in embodiments of method 500 implemented by a server and/or a software program package, the various rules to be executed on the healthcare data may be integrated into that programming.

In some embodiments, the method 500 proceeds by accessing 506 healthcare data. For example, healthcare data may be accessed from accessible data storage (e.g., system 200 having first data storage 204 and second data storage 206). Moreover, in some embodiments, accessing healthcare data may comprise accessing a healthcare database. As discussed in detail with regards to FIG. 2, such a database may be coupled to a network to enable access to data around the world. Similar to method steps 502 and 504, method steps 506 may also be optional in some embodiments.

The method 500, may proceed by executing 508 a rule on the healthcare data. Executing 508 the rule on the healthcare data may first comprise correlating 510 each of the rule elements 404 to an object model element 412. With respect to rule 400, “patient” may be correlated with the object model element for patient, “diabetes” may be correlated with the object model element for disease, “HbA1c glucose test” may be correlated with the object model element for procedure, and “flag for referral” may be correlated with the object model element for action. Examples of numerous object model elements include patient, medical history, procedure code, diagnosis code, doctor, patient ID, office visit, social history, provider, symptom, diagnosis, pharmacy, visit, exercise, review, communicate, evaluation, pay, choose, sue, defend, diagnose, refer, speak, compare, assess, publish, save, create, flag and the like. The previous examples are not intended to provide a complete list of various object model elements, and one having skill in the art will be able to identify various other elements that may be used to categorize rule elements 404. As discussed above, many, if not all, of the rule elements disclosed in Appendix A may be mapped to correlating object model elements of the general object model

In some embodiments, the object model element 412 may include both a general object model and a specific object model. For example, each of the object model elements discussed with respect to the above paragraph may belong to a general object model, in some embodiments. Moreover, these types of elements are generally applicable to most types of healthcare databases. In some embodiments, object model elements may need to be specified for non-general databases. For example, in an embodiment analyzing healthcare data for suspected claim fraud, a specific object model may be implemented in conjunction with a database of healthcare data created for fraud analysis that includes data elements specific to fraud analysis (e.g., history, appeals, contract, agreement, time, member beginning eligibility date, intervene, review bill, validate invoice, refuse/deny, and the like). In some embodiments, the specific object model will have elements that are mutually exclusive of the general object model, but in other embodiments, there may be overlap.

In some embodiments, executing 508 the rule on healthcare data may further include defining 512 the object model elements correlated to the rule using one or more localization indexes. With respect to FIG. 4, the object model element 412 for patient may be defined using one or both of two localization indexes 420. Similarly, the object model elements 412 for disease, procedure, and action may also be defined by one or both of two localization indexes 410.

In some embodiments, the localization index may provide an interface coupling the object model to a specific set of healthcare data. Moreover, in embodiments, the healthcare data to be analyzed is often stored using one or more various data structures, coding schemes, and/or languages specific to a given locale or type of database. For example, healthcare data in the U.S. may store data in English, and to represent the type of disease/procedure for a given patient that healthcare data may use ICD-9 (International Statistical Classification of Diseases and Related Health Problems) or Current Procedural Terminology (CPT—maintained by the American Medical association). However, though most sources of healthcare data in the U.S. may use this coding scheme, other sources may use ICD-10, ICD-CM, CPT 2010, or the like. Put more simply, the patient identifier in one data structure may be “Member ID” and, in another data structure, the same patient identifier may be “Member Number.” In one more example, a database in Spain may store its healthcare data in Spanish and use a coding scheme unique to Spain or even unique to that database.

To account for the differences that may exist in the organization and presentation of healthcare data, the localization index enables the linking of the object model elements to specific pieces of healthcare data (e.g., to specific members of a database, specific elements of a data structure, or the like). Additionally, the use of the localization indexes also enables the implementation of a rule across more than one sets/sources of healthcare data. Moreover, the use of the localization indexes further allow the ability to update how healthcare data may be stored (e.g. using ICD-9 to instead using ICD-10)—without having to amend or edit existing rules libraries. The only step that would need to be conducted would be to update the respective localization indexes.

Returning to FIG. 4, the object model elements may be defined using a localization index 420 labeled as the U.S. Data Table for the U.K. Data Table—or both. As such, a search for patients having diabetes but that have not had an HbA1c test may be performed across a set of U.S. healthcare data and a set of U.K. healthcare data. In this example, for the U.S. healthcare data, the patient object model element may be defined by the “Member ID” element of the set of U.S. healthcare data and the “NHS Number” of the set of U.K. healthcare data. Similarly, the procedure object model element may be defined by the specific codes/data structures used by the U.S. healthcare data source and the U.K. healthcare data source.

In some embodiments, a given object model element may be linked to more than one specific pieces of data within a healthcare data source. In various embodiments, the patient object model element may be linked to the gender, age, and patient name—in addition to member ID. In another example, procedure object model element may be linked to the date the procedure was completed, one or more procedure codes, a coding set, etc.

Returning to method 500, in some embodiments, the method continues by returning 514 analyzed healthcare data to an output data location. In some embodiments, the output data location may include a file (e.g., an XML file, a spreadsheet file, a word processing file, or the like), a database, or a programming object. Thus, returning 514 analyzed healthcare data may include outputting a file with the results of the rule execution, outputting analyzed healthcare data to a database, and/or making a program call using an programming object defined using the analyzed healthcare data. The type of output data to be output may be defined using one or more user inputs. Alternatively, the type of output data may be pre-defined by a particular software module or the like.

### APPLICATION EXAMPLES

The various embodiments of this disclosure enable the rapid and high performing production of adaptable analytics that may be customized according to architecture, geography, data source and/or coding system. The disclosure allows the ability to combine rules to efficiently deliver analytics across different combinations of healthcare data sources. Moreover, novel combinations of rule libraries enable the ability to conduct healthcare data analysis that was formerly far more cumbersome or not possible. Additionally, the flexibility of accessing data from various combinations of input data sources and output data to various output data locations enables the creation of unique applications. The following examples illustrate some of the novel uses of embodiments of the disclosed systems and methods:

### Call-Center Example

In one scenario, a nurse may be taking a patient assessment in a call center—asking a patient questions about a patient's general health. In a simple example, if the nurse enters a patient's high cholesterol value (e.g., LDL) into a case management system, a rule can be executed on this patient's health history data (e.g., on a healthcare claim records and/or medical records database) to determine whether this patient has had or would benefit from a cholesterol education session based on the results entered that day. The result of the rule execution can be output to the nurse in the call center immediately—in a file, a database, and/or a graphical user interface, and that information could be displayed directly with the patient on the phone. The patient could then be requested to join an education session. An example of the rule verbalization for this rule would be: If the patient has one or more instances of evidence of high cholesterol in the medical record, add the patient to the cholesterol education and management program. The data sets utilized in this example would be a database for the case management system functions pertaining to the management of care and a second database which houses the patient's medical claims and a potentially a third database containing laboratory results data.

In a second Call-Center scenario, an example of a combined rule would be that not only is the patient's historical cholesterol values checked but also other additional chronic conditions are assessed to determine whether this patient has multiple chronic conditions or outstanding referrals to a specialist. Based on this combination of resulting data, it may be determined that this patient has high cholesterol AND three chronic conditions with a referral to see an endocrinologist who has lower than average outcomes scores for their patients. Rather than a simple cholesterol education session, this patient may benefit more from a home health education session and while on the phone, the patient may be redirected to another provider whose outcomes scores are acceptable. Such data may be similarly output directly to the nurse's screen and discussed directly with the patient over the phone. This example expands on the rule indicated above and would be written as an additional rule in the system that would add further complexity to the overall system. An example of the rule verbalization for this rule would be: If the patient has been identified as an enrollee of the cholesterol education and management program; and also has any additional chronic conditions; and the patient is currently awaiting referral to a specialist, identify the specialist and verify that provider's quality of care. If the quality of care is below XX %, identify an alternative doctor for referral. The data sets utilized in this example would be a database for the case management system functions pertaining to the management of care and a second database which houses the patient's medical claims, a third database containing laboratory results data and a fourth data set which would be housed by provider contracting unit containing specialist outcomes results data.

### Enhanced Fraud Analysis

In a third scenario, a healthcare provider company may want to conduct fraud analysis on patient who have not been with their health plan for very long. One cost-saving solution for the healthcare company would be to execute a rule using data from a fraud-based healthcare data source and this patient's health history data (e.g., on a healthcare claim records and/or medical records database). Such a rule may seek to find those patients having chronic conditions and/or high risk cost cases that are associated with providers with a high percentage of potentially fraudulent cases. Each of these patients may be automatically referred to a more secure provider—therefore saving costs for the healthcare company. Moreover, a database may be created to keep track of these individuals before and after their referral for quality of care purposes. An example of a possible verbalization for this rule is: If the patient is diagnosed with a chronic or high cost condition within the first 30 days of enrollment, and the provider of services for that chronic condition is on the ‘provider fraud watch’ listing’ then flag this patient claims data to fraud detection unit. The data sets involved in this example would be both the enrollment data system, the claims system data and the fraud and abuse tracking data tables.

### Enhanced Patient Referrals

In a fourth scenario, a healthcare primary care provider may seek to direct patients to a specialist provider based on a patient's condition, a provider's specialty, and additionally a provider's capacity (something that is typically not available to clinical systems). Various rule libraries may be combined including referral rules that help determine which provider a particular patient should be referred to based on that patient's medical history and the providers' expertise as well as compliance rules that track how long it will likely take a patient to get an appointment in that doctor's schedule (e.g., 8 days in advance or 8 weeks in advance). Such a combination of data sources and rule libraries may enable the referral of patients to providers based on capacity instead of only condition and specialty. A possible verbalization of this rule is: If a specialist provider's office appointment wait time is greater than X then redirect the patient's referral to a provider whose office appointment wait time is less than X The data tables used in this example would be the claims data tables, the referral data tables and the provider credentialing and tracking data tables used for compliance.

### Rule Configuration Module

As discussed earlier in this disclosure, with respect to receiving 502 a rule verbalization, in some embodiments, the rule verbalization may be received from a rule configuration module. Such a rule configuration module may be configured to efficiently allow the creation, modification, duplication, and/or deletion of business rules. More particularly, anile configuration module may be configured to more efficiently allow a collection of rules to create a rule library or a series/succession of rules to create a rule flow.

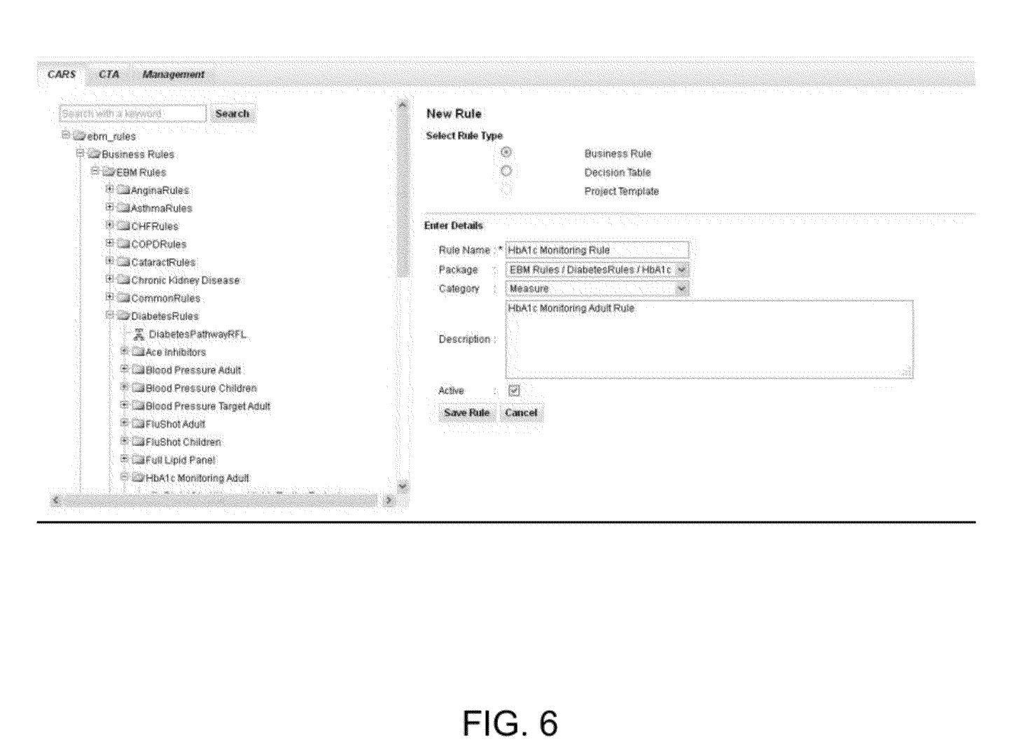

FIG. 6 illustrates a screenshot example of a specific embodiment of creating a new rule within a rule configuration module. As shown, in this embodiment, the user interface enables the creation of a “Rule Name” and “Description.” Additionally, this specific rule is associated with a “Package.” As shown, a “Package” is simply an alternative term for a Rule Library. In FIG. 6, this specific rule is commonly associated with Evidence Based Medicine (EBM) Rule data sources. Within EBM Rule data sources, this rule is specific to Diabetes Rules, and even more specifically the Hb1Ac test. This example demonstrates a basic tenet that rules libraries may be embedded within one another. As is commonly associated with user interfaces within the art and depicted in the figure, the new rule may be saved and organized within a project. Moreover, a saved rule may be edited, deleted, or otherwise modified. Additionally, various metadata may be stored, associated, and accessed including but not limited to name, status, expiration date, effective date, locale, categories, template, active, folder, group, created by, last changed by, last changed on, created on, and/or type.

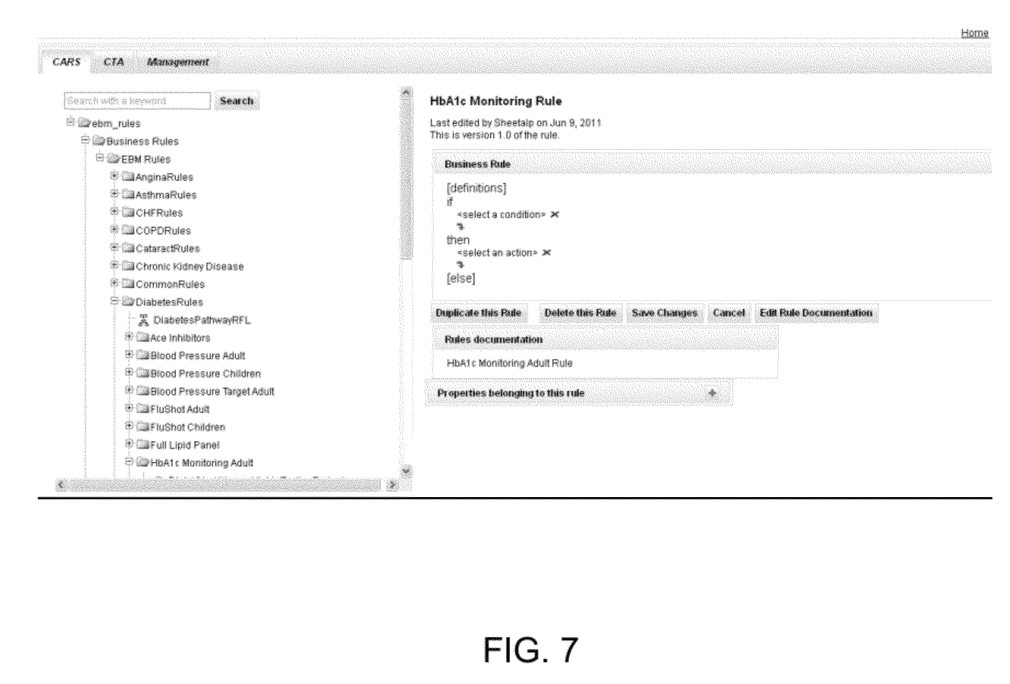

FIG. 7 illustrates a screenshot example of a specific embodiment of defining a new rule. As shown, in this particular embodiment, a rule is defined for the rule created in FIG. 6. Moreover, this embodiment has pre-defined logical elements “if” and “then.” Though “if-then” statements are a preferred embodiment for a rule structure, various embodiments of the user interface may have different/selectable/modifiable configurations of logical elements (e.g., qualifiers, conditionals, and operators) that form the structure of a rule. As show in FIG. 7, the rule configuration module may be configured to enable the selection of rule elements—in this case, conditions and actions—to complete the rule creation. FIG. 7 demonstrates the ability to create a simple rule, but in practice, the rule configuration module can be used to create complex rules with various logical elements and rule elements. More particularly, as shown in figure, this embodiment creates Rules Documentation in response to the rule libraries associated with the rule. In certain embodiments, the Rules Documentation may be edited, customized, and/or downloaded.

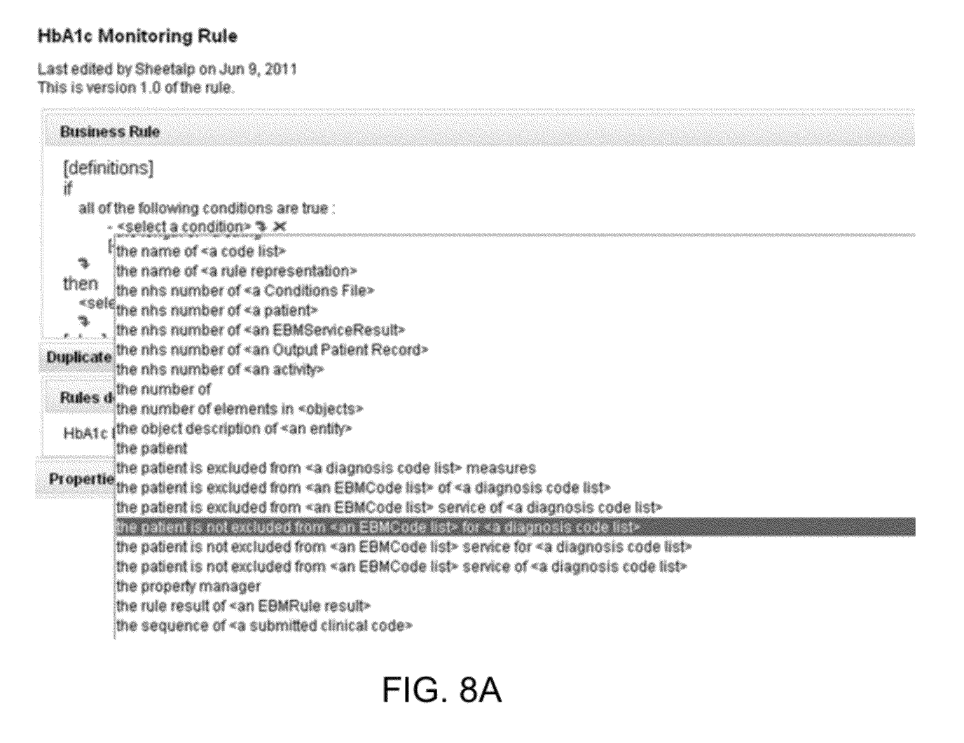

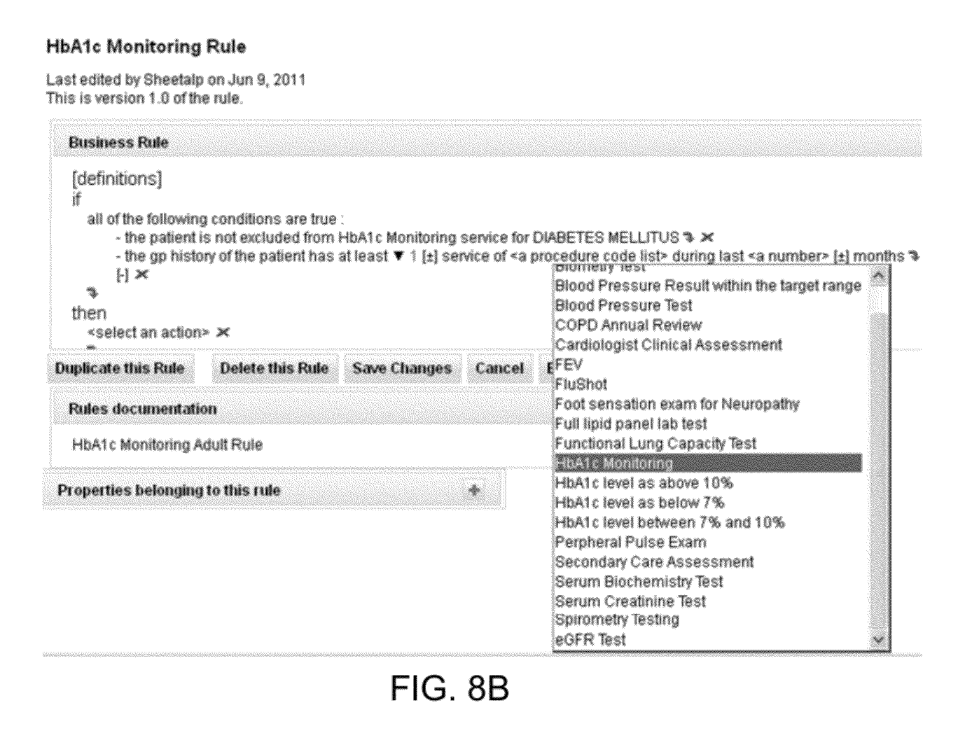

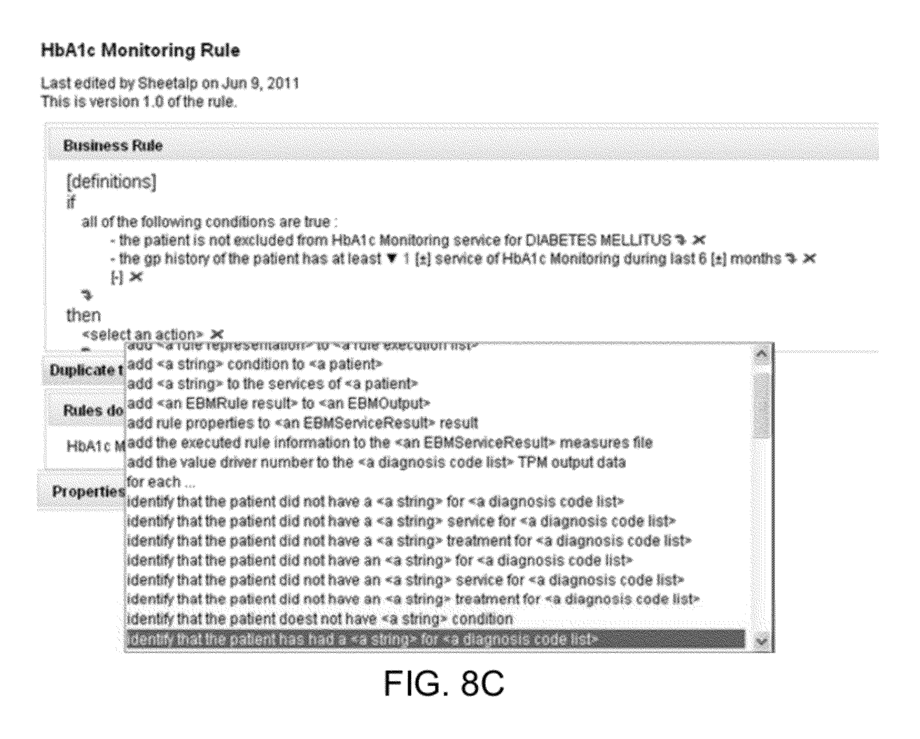

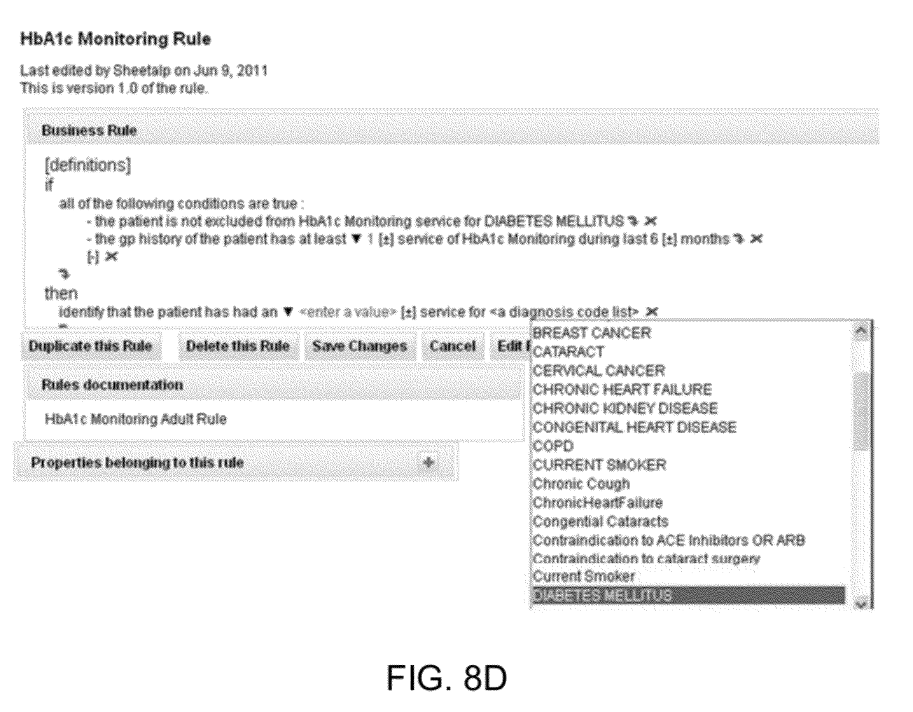

FIG. 8 illustrates a series of additional screenshots of a specific embodiment of editing the rule created and defined in FIGS. 6 and 7. Specifically, FIG. 8A illustrates the step of selecting various rule phrases. Particularly, the figure illustrates “selecting a condition” from a list of conditions. These various rule conditions are comprised of commonly used logical elements, rule elements, and object model elements. In some embodiments, these commonly used selectable rule actions may be associated with a particular architecture, geography, data source, and/or coding system particular to a rule library or healthcare domain. In some embodiments, these commonly used rule actions (are more particular the rule elements/object model elements within these rule actions) may be associated with particular object model elements. For example, in the pull down menu in FIG. 8A, the phrase, “the patient is not excluded from <EBMCode list> for <a diagnosis code>” is selected.

In some embodiments, rule phrases may provide further options for choosing additional rule phrases. As shown in FIG. 8B, the <EBMCode list> and <a diagnosis code> provide further options for configurability of the selected phrase. More particularly, “HbA1c Monitoring” has been selected from the <EBMCode list> and Diabetes Mellitus has been selected from the <a diagnosis code> list. Additionally, FIG. 8A also illustrates several additional features regarding rule editing—such as the ability to add or delete various rule phrases and the ability to selectively choose number values. In the figure, the rule is shown to be, “the gp history of the patient has at least 1 service of HbA1c Monitoring during the last <a number> months.”

The pull-down menus in FIG. 8B also demonstrate the ability to select from a variety of rule phrases that may each be associated with an object model element for disease or condition. Such pre-association with a particular object model element may facilitate the execution 508 of a rule. Moreover, the step of correlating a rule element with an object model element may be easier. Here, the selected diabetes rule element can readily be correlated with an object model element regarding procedure codes. However, this approach does not prohibit the ability to re-characterize the rule action to be associated with other object model elements.

The screenshot in FIG. 8C together with FIG. 8D continues by editing the output of the rule. The particular output condition defined is to identify that a patient the diabetes testing determined in the “if” statements described in FIGS. 8A and 8B.

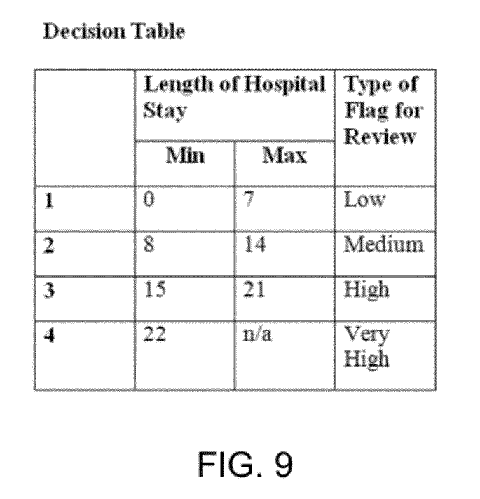

FIG. 9 illustrates an alternative user embodiment for creating a rule using a rule configuration module. As shown in the figure, a decision table may be used to create a rule. With respect to the figure, each row in the table may be define part of a rule. For example, row 1 may be translated to read, “If the length of a patient's hospital stay is greater than 0 days and less than or equal to 7 days years, then flag that hospital stay to characterize it as “low.” Each of the rows may be put together to form a rule.

### Rule Testing Module

In certain embodiments, the rule configuration module may also be linked to a rule testing module. The rule testing module may enable the testing of various rules within specific test scenarios. Similar to the rule configuration module, a testing model may enable the ability to create new test, save tests, modify existing tests, and organize tests in to projects.

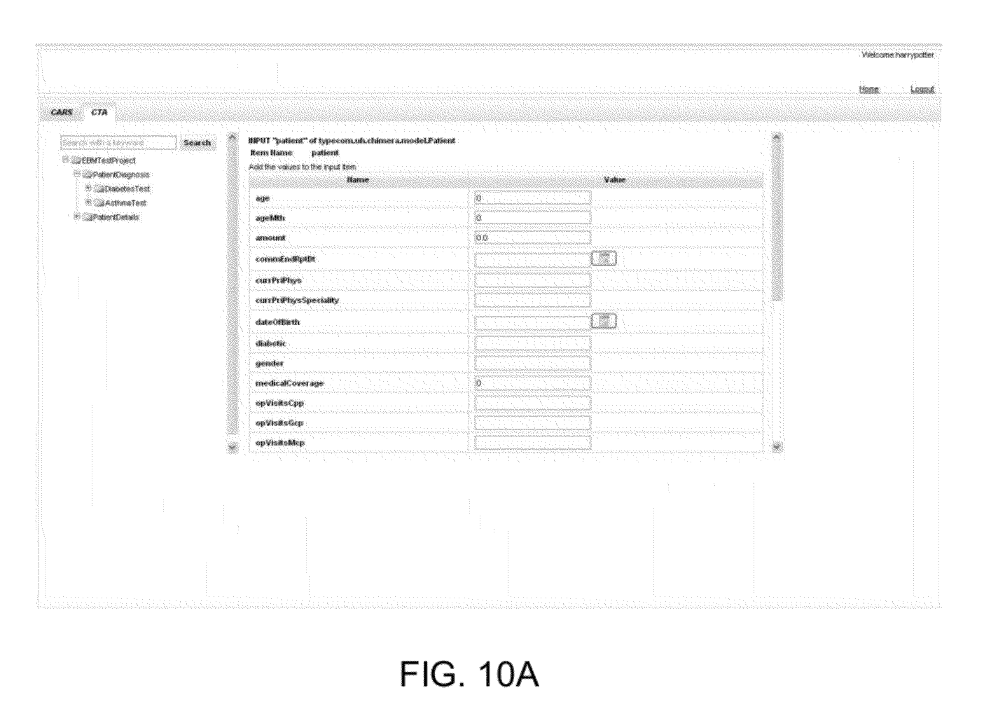

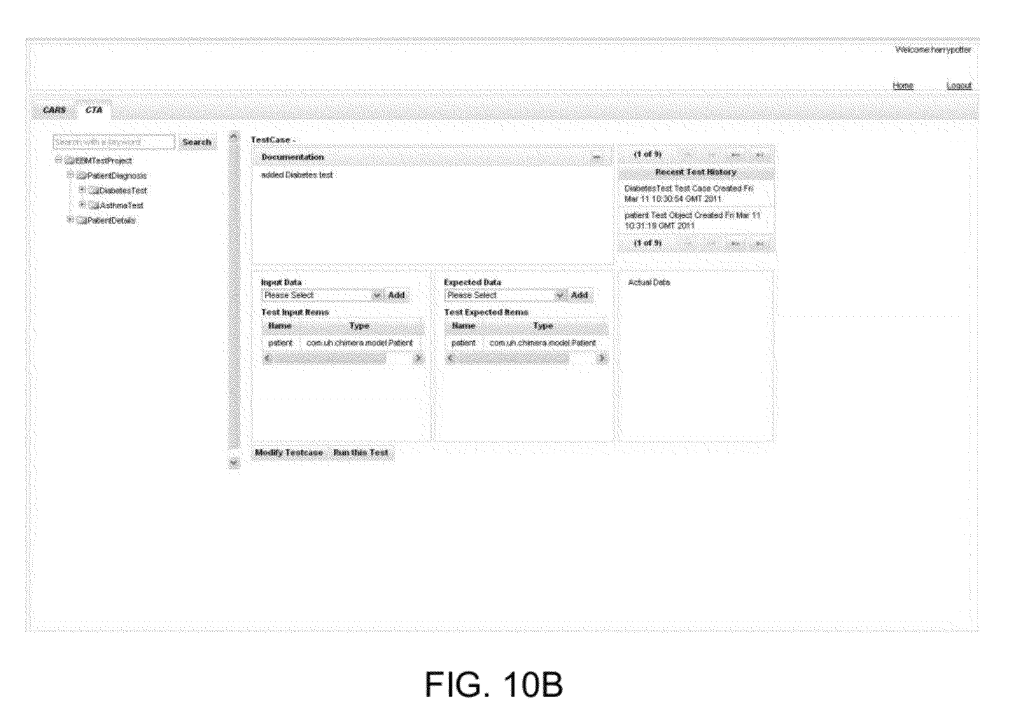

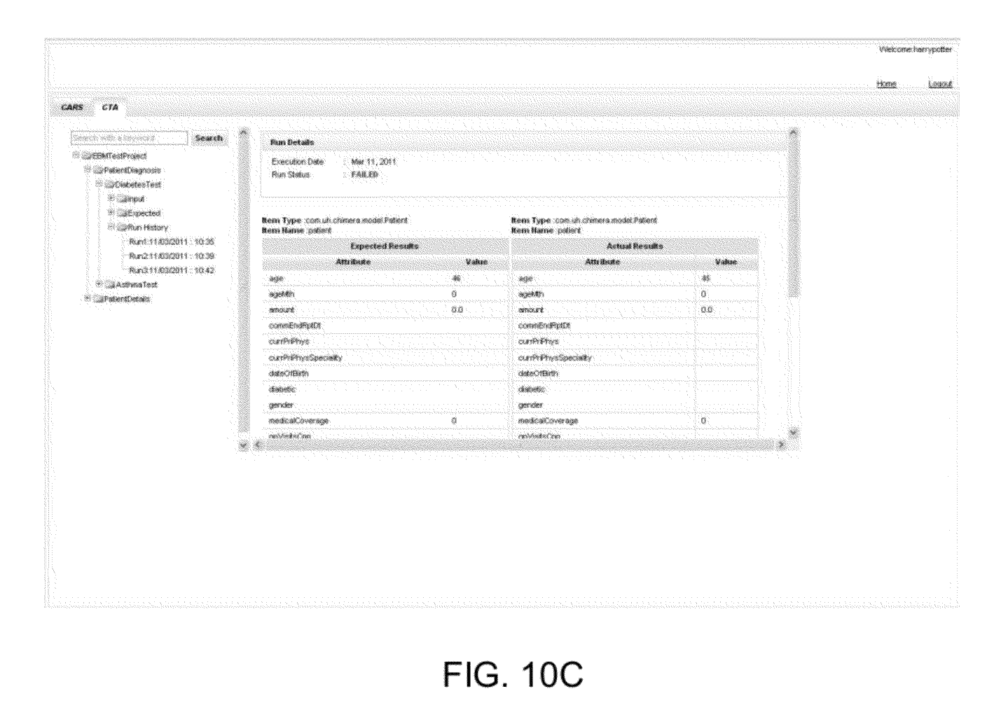

Specific embodiments of the rule testing module may provide the ability to use a configurable data source. More specifically, rules are executed on a “set of data.” Rather than testing the rule (or a set of rules) on a live set of data (e.g., the actual database comprising millions of pieces of data), on a more particularized set of data. Such a particularized set of data may include certain boundary conditions that can test various aspects of the rule. For example, if specific rule is attempting to find patients older than 45, patient data may be created for patients ranging in age from 44 through 46. As such, the ability for the rule to successfully identify patients over the age of 45 can be tested. As shown with respect to FIG. 10A, various embodiments of the rule testing module may be configured to enable the creation of specific data elements within a particularized set of data for testing. Moreover, as shown in FIG. 10B, various embodiments of the rule testing module may be configured to allow the definition of both input data elements and expected data elements. As shown with respect to FIG. 10C, the expected data elements may be compared with the actual results to test a given rule. As shown in the figure, a patient having an age of 46 was expected to be retrieved, and instead the patient's age was 45. As such, the test failed. In other embodiments, a failure of a test may not return a result at all, and rather may return a software exception. Such a failure may indicate that the particular rule, its input data source, or other configuration variable needs to be edited or modified.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A system for analyzing healthcare data, the system comprising:
a data access module configured to access healthcare data;
a server in data communication with the data access device configured to:
execute a rule, the rule comprising one or more rule elements, on the healthcare data to create analyzed healthcare data, wherein executing a rule comprises:
correlating each rule element with an object model element; and
defining the object model elements correlated to the rule elements using one or more localization indexes linked to the accessed healthcare data; and
return the analyzed healthcare data to an output data location.

2. The system of claim 1,
wherein the accessed healthcare data comprises a first set of accessed healthcare data and a second set of accessed healthcare data;
wherein the one or more localization indexes comprise a first localization index linked to the first set of accessed data and a second localization index linked to the second set of accessed data.

3. The system of claim 2, wherein the first set of accessed data comprises data in a first language and the second set of accessed data comprises data in a second language.

4. The system of claim 2, wherein the first set of accessed data comprises data organized using a first coding scheme and the second set of accessed data comprises data organized using a second coding scheme.

5. The server of claim 1, further configured to receive a rule verbalization expressing a rule.

6. The server of claim 5, the server further configured to parse the rule verbalization to determine the one or more rule elements of the rule.

6.5. The server of claim 5, wherein the rule verbalization is received from a rule configuration module configured to facilitate the creation of a rule verbalization.

7. The system of claim 1, wherein the data access module is configured to receive data from at least a file, a database, and a programming object.

8. The system of claim 1, wherein the output data location comprises at least a file, a database, and a programming object.

9. A method for analyzing healthcare data comprising:
accessing healthcare data;
executing a rule, the rule comprising one or more rule elements, on the healthcare data to create analyzed healthcare data, wherein executing the rule comprises:
correlating each rule element with an object model element; and
defining the object model elements correlated to the rule elements using one or more localization indexes linked to the accessed healthcare data; and
returning the analyzed healthcare data to an output data location.

10. The method of claim 9,
wherein the accessed healthcare data comprises a first set of accessed healthcare data and a second set of accessed healthcare data;
wherein the one or more localization indexes comprise a first localization index linked to the first set of accessed data and a second localization index linked to the second set of accessed data.

11. The method of claim 10, wherein the first set of accessed data comprises data in a first language and the second set of accessed data comprises data in a second language.

12. The method of claim 11, wherein the first set of accessed data comprises data organized using a first coding scheme and the second set of accessed data comprises data organized using a second coding scheme.

13. The method of claim 9, further comprising receiving a rule verbalization expressing a rule.

14. The method of claim 13, further comprising parsing the rule verbalization to determine the one or more rule elements of the rule.

14.5. The method of claim 13, wherein the receiving the rule verbalization comprises facilitating the creation of a rule verbalization.

15. The method of claim 9, health data is received data from at least a file, a database, and a programming object.

16. The method of claim 9, wherein the output data location comprises at least a file, a database, and a programming object.

17. A computer program product comprising a computer readable medium having computer usable program code executable to perform operations for analyzing healthcare data, the operations of the computer program product comprising:
accessing healthcare data;
executing a rule, the rule comprising one or more rule elements, on the healthcare data to create analyzed healthcare data, wherein executing the rule comprises:
correlating each rule element with an object model element; and
defining the object model elements correlated to the rule elements using one or more localization indexes linked to the accessed healthcare data; and
returning the analyzed healthcare data to an output data location.

18. The computer program product of claim 17,
wherein the accessed healthcare data comprises a first set of accessed healthcare data and a second set of accessed healthcare data;
wherein the one or more localization indexes comprise a first localization index linked to the first set of accessed data and a second localization index linked to the second set of accessed data.

19. The computer program product of claim 17, wherein the first set of accessed data comprises data in a first language and the second set of accessed data comprises data in a second language.

20. The computer program product of claim 19, wherein the first set of accessed data comprises data organized using a first coding scheme and the second set of accessed data comprises data organized using a second coding scheme.
